(19) United States
(12) Patent Application Publication
(10) Pub. No.: US 2014/0050830 A1
(43) Pub. Date: Feb. 20, 2014

(54) METHODS OF PROCESSING RAW FOODS AND RELATED FOOD PRODUCTS

(71) Applicants: Ethan J. Whitbeck, McKinney, TX (US); Billy M. Groves, Rogers, AR (US); Francis M. Henderson, Rogers, AR (US)

(72) Inventors: Ethan J. Whitbeck, McKinney, TX (US); Billy M. Groves, Rogers, AR (US); Francis M. Henderson, Rogers, AR (US)

(73) Assignee: GROVAC SYSTEMS INTERNATIONAL L.C., Bentonville, AR (US)

(21) Appl. No.: 14/001,107

(22) PCT Filed: Feb. 24, 2012
(86) PCT No.: PCT/US12/26616

§ 371 Date: Nov. 6, 2013

Related U.S. Application Data
(60) Provisional application No. 61/446,371, filed on Feb. 24, 2011.
(60) Provisional application No. 61/477,957, filed on Apr. 21, 2011.
(60) Provisional application No. 61/544,358, filed on Oct. 7, 2011.

(51) Int. Cl. A23L 1/015; A23L 1/36

(52) U.S. Cl. CPC A23L 1/0155; A23L 1/36
USPC 426/331; 426/634; 426/641

(57) ABSTRACT

A method of eliminating the off-flavor of soy beans, wherein the off-flavor of the soy beans is not related to geosmin, the method comprising:

providing soy beans in a vacuum tumbler equipped with lifting ribs;
tumbling the soy beans in a temperature range from about 0.5° C. to about 27° C. in an alternating environment of a vacuum and an acidic solution that is not hypotonic and does not comprise sodium, wherein the lifting of the ribs lift the soy beans completely out of the acidic solution when the soy beans are in the vacuum environment;
and
removing at least a portion of the moisture from the soy beans; wherein said process produces soy beans that have no-off flavor are free of trans fats and retain good flavor is described along with related products.

### CROSS-REFERENCE TO RELATED APPLICATIONS

This application claims the benefit of priority to U.S. provisional application 61/446,371, filed Feb. 24, 2011, U.S. provisional application 61/447,957, filed Apr. 21, 2011, and U.S. provisional application 61/544,358, filed Oct. 7, 2011, all of which are hereby incorporated by reference in their entirety.

### FIELD OF THE INVENTION

The present invention relates in general to methods of processing raw food and food prepared by such processes.

### BACKGROUND

Many important issues relate to the processing of raw foods, including taste, shelf-life nutrition and safety. One issue, microbiological control, is of vital importance in raw food processing. Vegetables, fruits, meats, fish and shell fish may be exposed to various pathogens in the form of mobile bacteria such as for example Escherichia coli, Salmonella enteritidis, Salmonella typhimurim, Campylobacter jejuni, Campylobacter coli, Campylobacter lari, and in the form of biofilms such as for example Listeria monocytogenes, Pseudomonas fluorescens, Pseudomonas aeruginosa, Enterococcus faecium, and Staphylococcus aureus.

Some methods of processing raw foods rely upon chlorine baths or sprays. Poultry processing, for example, is normally accomplished in the manner shown in FIG. 1. The birds (possibly carrying salmonella) are received by truck and transferred to an area where they are slaughtered and bled. Slaughtered birds are then de-feathered using hot water and steam and raising their body temperature above 37° Celsius. Leaving the temperature at that level for any length of time creates multiple problems. Body temperatures must be quickly reduced below 5.5° Celsius as soon as possible.

De-feathered birds go to the Evisceration Station where the feet, heads, lungs, abdominal contents and trim are removed and sent to rendering. Birds then proceed to washing and chilling in the chill tank that contains chlorine solution. Time spent in the chill tank chlorine solution can be as much as 60 minutes. Much of the chlorine in the chill tank becomes bound with organic matter from the birds being processed. This also increases the pH of the solution decreasing the bacterial effectiveness of the chlorine. Similar processes are used with beef, pork and lamb and some fish.

A need exists for efficiently processing all types of raw foods, wherein variables that destroy bacteria and other pathogens are monitored and maintained continuously. Thus, in one embodiment, an objective of the present invention is to develop a continuous flow apparatus that will accomplish the essential function of removing Salmonella, Campylobacter, E. coli, and Listeria pathogens plus spoilage bacteria. The process should also delay oxidative decomposition but remain compatible with the addition of other infused antioxidants at the processor's discretion.

Soy beans are one type of raw food that could benefit from such a continuous pathogen destroying process. However, raw soy beans would also benefit from a process that would enhance flavor while maintaining good nutrition. The nutritional benefits of soy are significant and well-established. Soy beans derive 35 to 38 percent of their calories from protein compared to approximately 20 to 30 percent in other legumes and much less in cereals and grains. Soy protein is of the highest quality. Under new guidelines adopted by the Food and Drug Administration and the World Health Organization for evaluating protein quality for children and adults, soy protein isolate receives a rating of 1, which is the highest possible score. This means that the quality of soy protein is equal to that of meat and milk proteins yet, since it comes from a plant, it is both more environmentally friendly to produce and easier to process and transport than animal-based protein. Vegetable proteins also have the advantage of causing less calcium loss through the kidneys.

By adding soy flour to wheat, the protein content of bread can be increased three to five times. This makes the bread much healthier for diabetics, for example, who tolerate protein much better than carbohydrates.

About 40% of the calories from soy beans come from fat. Most of the fat in soy beans is unsaturated. Polyunsaturated (primarily linoleic acid), monounsaturated (oleic acid) and saturated (primarily palmitic acid) fats make up 54 percent, 23 percent, and 16 percent respectively of the fat in soy beans. The polyunsaturated fat content of soy beans is of interest because it includes linolenic acid (seven percent of the total fat content), an omega-3 fatty acid. Soy beans are one of the few plant sources of omega-3 fatty acids. Omega-3 fatty acids may be essential nutrients for infants and they may also help to reduce risk of both heart disease and cancer.

Soy also contains high concentrations of isoflavones which have many health benefits including reduction of cholesterol, easing of menopause symptoms, prevention of osteoporosis and reduction of risk for certain cancers (prostate cancer and breast cancer). Isoflavones are antioxidants which protect our cells and DNA against oxidation. Soy beans, like other whole, unprocessed plant foods, contain dietary fiber. One serving of soy beans provides approximately eight grams of dietary fiber. About 30 percent of the fiber in soyfoods is soluble fiber. Finally, soy beans are also rich in calcium, iron, zinc and B vitamins, and oil soluble vitamins such as vitamin E.

Because they are a plant, soy beans can be processed into a variety of forms that are easily transportable and storable, with extended shelf life, without the refrigeration and other costs associated with transporting and storing meat and dairy products.

Despite all the nutritional health benefits afforded by soy beans, they have suffered from an offensive taste that has greatly diminished their appeal as a human food source. In some cases, the off-flavor of soy beans may be attributed to geosmin which is an organic compound produced by microbes in water. However, this is not the only source of off-flavor. One of the oldest theories about the cause of the off flavor of soy beans centers around linolenic acid. Linolenic acid is one of the component fatty acids of soy bean oil, linseed oil, perilla oil, and other oils that develop painty-grassy flavors. The current predominant theory about the source of the off-flavor of soy beans is related to the activation of the lipoxygenase enzyme (LOX). The off-flavor derives from lipid oxidation initiated by these enzymes. However, it has been shown that the off-flavor can be caused by oxidation from any source, including natural decaying processes, mitochondrial, cytoplasmic and bacterial oxidation. In order to derive some of the nutritional benefits from soy while eliminating this taste, industry has developed methods of creating soy-based protein isolates and concentrates that are very expensive and also have resulted in diminished nutritional value of the soy bean by, for example, reducing its fat content and the amount of vitamins and minerals present.

Moreover, oil derived from soy beans typically undergoes hydrogenation a process that extends its shelf-life by delaying the onset of oxidative decay and rancidity. Hydrogenation involves exposing soy bean oil to heat and pressure in the presence of certain metals and hydrogen. Not only is the process costly in time and energy, but also trans fatty acids, an extremely undesirable byproduct of hydrogenation, is created. Trans fatty acids have been determined to contribute significantly to heart disease. The FDA last year issued regulations requiring that foods containing more than 0.5 grams of trans fat be so labeled, and many jurisdictions, including major American cities, are imposing regulations that severely restrict the serving of foods containing trans fats in restaurants.

Therefore, it is a desire to provide a process that reduces the bad taste and increase the shelf life of soy beans and products made therefrom, without compromising the nutritional value of the soy. Furthermore, such processing should avoid the formation of harmful trans fatty acids and should stabilize the fat in the soy beans from oxidation from any source, internal or external. Finally, the process should be energy efficient and not use elevated temperatures and the requisite large energy consumption associated with such processes.

### SUMMARY OF THE INVENTION

In one embodiment, the invention is directed to a raw food processing system comprising a) providing at least three Grovac machines containing a vacuum and an aqueous solution and a means for conveying the food through the vacuum and aqueous solution in each Grovac machine continuously; b) providing raw food; c) subjecting raw food to treatment in a first Grovac machine; d) subjecting the product of c) to a second Grovac machine; e) subjecting the product of d) to a third Grovac machine; wherein if the food is poultry, the poultry is eviscerated between treatment in the first Grovac machine and second Grovac machine; wherein the aqueous solution in each comprises a sodium chloride and organic acid; and wherein the temperature of the first Grovac machine is between 10 and 24 degrees centigrade, the temperature of the second Grovac machine is between 5 and 15 degrees centigrade and the temperature of the third Grovac machine is between 0.1 and 10 degrees centigrade. This process may remove pathogens from the raw food.

In another embodiment, the invention is directed to a poultry processing system for removing pathogens from poultry comprising: a) providing at least three Grovac machines containing a vacuum and an aqueous solution and a means for conveying the poultry into and through the vacuum and aqueous solution in each Grovac machine continuously; b) providing de-feathered poultry; c) subjecting de-feathered poultry to treatment in a first Grovac machine; d) subjecting the product of c) to a second Grovac machine; e) subjecting the product of d) to a third Grovac machine; wherein the poultry is eviscerated between treatment in the first Grovac machine and second Grovac machine; wherein the aqueous solution in each comprises a sodium chloride and organic acid; and wherein the temperature of the first Grovac machine is between 10 and 24 degrees centigrade, the temperature of the second Grovac machine is between 5 and 15 degrees centigrade and the temperature of the third Grovac machine is between minus 2.2 and 10 degrees centigrade.

In this poultry processing embodiment, the processing time in the second Grovac machine is longer than the processing in the first Grovac machine and the processing in the third Grovac machine is shorter than the processing of either the first or second Grovac machine. The poultry may be selected from the group consisting of chickens, ducks, turkey, geese, quail, pigeons, doves and pheasants.

In another embodiment, the invention is directed to a raw food processing system comprising: a) providing at least one Grovac machine containing a vacuum and an aqueous solution and a means for conveying the raw food into and through the vacuum and aqueous solution in at least one Grovac machine continuously; b) providing raw food; c) subjecting the raw food to treatment in at least a first Grovac machine; wherein the aqueous solution comprises a sodium chloride and organic acid; and wherein the temperature of the at least first Grovac machine is between −2.2 and 24 degrees centigrade. This process may be used to remove pathogens form the raw food.

In another embodiment, the present invention relates to processing soy beans for consumption and/or use of the soy beans and products derived therefrom. Accordingly, in one embodiment, the invention is a method of processing soy beans comprising providing soy beans in a Grovac machine that is a vacuum tumbler equipped with lifting ribs and tumbling the soy beans in an alternating environment of a vacuum and an acidic solution. The soy beans are removed from the tumbler and a portion of moisture is removed from the soy beans. A soy bean product made by this process is substantially free of trans fatty acids and has an Iodine Value in a range from 90 to 120. The process improves the taste and extends the shelf life of soy beans. This process also may remove pathogens from the soy beans and may either be a batch process or a continuous process.

In another embodiment, the invention is a method of eliminating the off-flavor of soy beans, wherein the off-flavor of the soy beans is not related to geosmin, the method comprising:

providing soy beans in a vacuum tumbler equipped with lifting ribs; tumbling the soy beans in a temperature range from about 0.5° C. to about 27° C. in an alternating environment of a vacuum and an acidic solution that is not hypotonic and does not comprise sodium, wherein the lifting of the ribs lift the soy beans completely out of the acidic solution when the soy beans are in the vacuum environment;

and
removing at least a portion of the moisture from the soy beans; wherein said process produces soy beans that have no-off flavor are free of trans fats and retain good flavor.
The soy beans processed by this method may be ground to produce soy bean meal.
In another embodiment, the invention relates to soy meal produced by the above method.
In another embodiment, the invention relates to food products comprising the soy meal produced by the above method.
In one embodiment, the food products are soy and meat products.
In another embodiment, the food products are snack foods such as “soy puffs.”

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a diagram depicting a typical prior art method for processing poultry.

FIG. 2 is a diagram depicting one embodiment of the method of processing poultry according to the present invention.

FIG. 3 is a schematic showing a cross-section of a Grovac machine adapted for continuous flow.

FIG. 4 is a block diagram showing the processing of soy beans in accordance with embodiments of the present invention.

FIG. 5 is a schematic of an example of a cross-section of a prior art puff-extrudate die.

FIG. 6, exemplary schematic of Grovac machine.

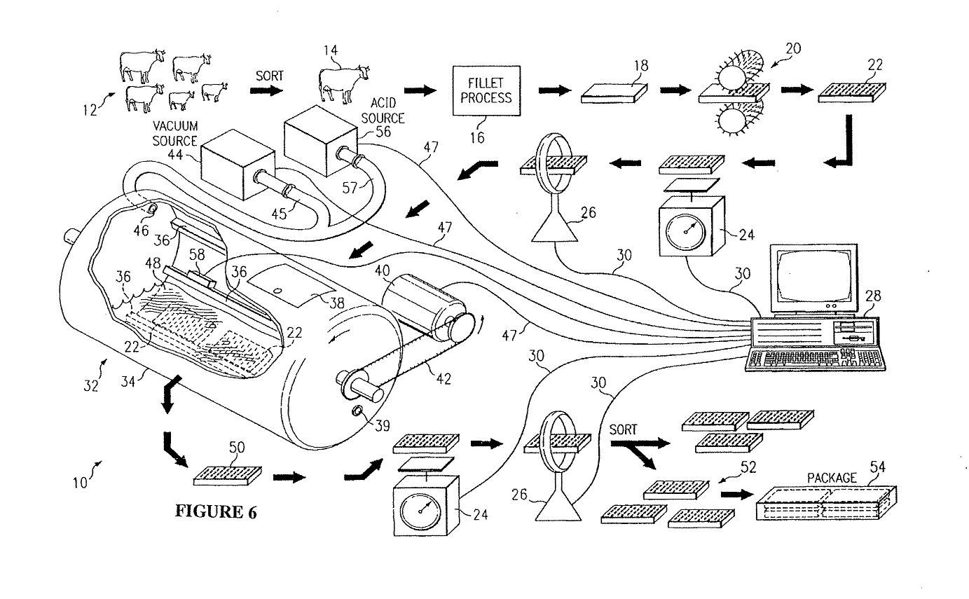

### DETAILED DESCRIPTION

The processes of the present invention are intended for use in commercial raw food such as meat, vegetable and fruit processing. The purposes of the processing includes one or more of removing pathogens, enhancing flavor, stabilizing fat, enhancing and shelf-life of the food product. The raw foods include all meats, seafood, fruits and vegetables. However, the processes of the invention could also be applied to non-edible products, such as flowers and other ornamental plants. The preferred vegetables are legumes.

“Meat” is intended to include, but is not limited to beef, lamb, pork, fish, shell fish and poultry. By “poultry” is meant domesticated birds kept by humans for meat or eggs. Typically, these birds or fowl are members of the superorder Galloanseae, especially the order Galliformes, which includes chickens, quails and turkeys and the family Anatidae, which includes waterfowl, such as ducks and geese. Poultry also includes other birds, such as pigeons, doves and pheasants. “Vegetables” includes but are not limited to, any leafy vegetable, legumes, such as soy beans, nuts, tubers, members of the cruciferous family, asparagus, carrots, okra, peppers, onions, celery, cucumbers, gourds, and artichokes. Fruit includes, but is not limited to tomatoes, pineapples, grapes, apples, peaches, apricots, strawberries, blackberries, cantaloupe, avocadoes and plums.

By “pathogens” is meant any microbe commonly associated with raw foods. For example, common poultry pathogens include Escherichia coli, Salmonella enteritidis, Salmonella typhimurim, Campylobacter jejuni, Campylobacter coli, Campylobacter lari, and in the form of biofilms such as for example Listeria monocytogenes, Pseudomonas fluorescens, Pseudomonas aeruginosa, Enterococcus faecium, and Staphylococcus aureus and any bacteria associated with spoilage.

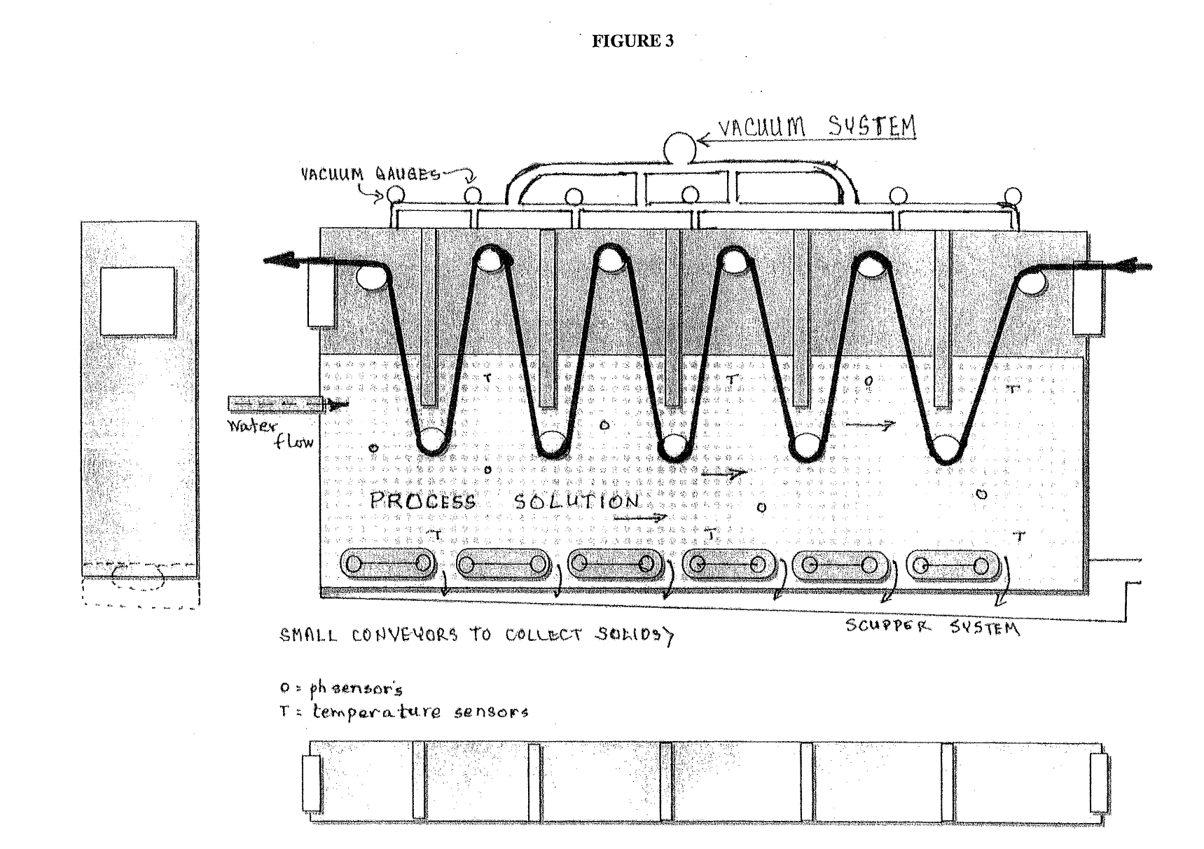

Grovac is a tradename. By “Grovac machine” is meant a flow dip machine or a vacuum tumbler, which described in one or more of the following U.S. patents: U.S. Pat. No. 5,543,163, U.S. Pat. No. 6,896,921 or U.S. Pat. No. 7,007,594, U.S. Pat. No. 7,838,054, U.S. patent application Ser. No. 11/737,848, and U.S. patent application Ser. No. 12/440,751, each of which incorporated herein by reference in its entirety. A “Grovac process” may use one or more Grovac machines. However, the essential feature of any Grovac process is the “treatment” of a product by cycling the product to be treated between a vacuum and an aqueous solution containing an organic acid. This can be accomplished in a variety of ways, including but not limited to moving the product by tumbling in and out of the solution/vacuum environment, rotating, dipping, or the movement of the product along a conveyor. The product may be hung, as in the case of poultry, beef, pig or lamb carcasses, or may be moved in baskets or other containers, as in the case of fish, shell fish, vegetables or fruits. The cycling between the vacuum and the solution may occur by way of increasing and then decreasing levels of solution to periodically expose the product to the vacuum. In one embodiment, which involves a continuous, as opposed to batch process, the preferred Grovac machine has been adapted for continuous flow and is shown in FIG. 3. In FIG. 3, food products, exemplified by poultry, are attached to a line which is a shackle conveyor and which moves continuously in and out of the vacuum/solution. As such, the poultry is dipped in and out of the solution. The temperature and pH of the solution is monitored throughout the process. In one embodiment, the shackle conveyor also moves the poultry from one to the other subsequent Grovac machines and to the final stages for processing and packaging.

It should be understood by the skilled artisan, however, that the process according to the present invention can be a combination batch and conveyor process or just a conveyor process and can involve one or more Grovac machines. For instance, in one embodiment, the raw foods are rotated in a Grovac vacuum tumbler, as described in U.S. Pat. No. 6,896,921 with description and figures, which is herein incorporated by reference, then removed by conveyor or other means to a second Grovac vacuum tumbler and so on. This is a combination conveyor and batch process. In an alternative conveyor only process, the raw foods are dipped in and out of the solution and vacuum continuously along a conveyor. According to the process of one embodiment of the invention, at least three Grovac machines are used in sequence to process the raw food product. The machines may be the same or different. In one embodiment, the Grovac machines have different lengths. For instance, the Grovac machines may range in length from 8 to 100 feet. Each Grovac machine contains an aqueous solution comprising an organic acid. In some cases, the aqueous solution also contains sodium chloride. In some cases, specific ingredients are not used. For instance, no phosphates are used during the Grovac process when the purpose of such process is to remove pathogens. In another instance, sodium is not used, particularly for treating soy beans. Thus, in a continuous Grovac process, the aqueous solutions of the individual machines may differ from each other as different goals are achieved with different machines. In one continuous process embodiment, the aqueous solution comprises ascorbic acid and sodium chloride with a combined concentration of 1.25% weight/volume. The pH of the aqueous solution should be from about 1.8 to 3.4.

The temperature, cycle ratio between solution and vacuum, and total processing time in each Grovac machine also may differ. For instance, in one embodiment, the first Grovac machine has a temperature between 10 and 24 degrees centigrade, preferably between 15 and 21 degrees centigrade and most preferably 17 degrees centigrade; the temperature of the second Grovac machine is between 5 and 15 degrees centigrade, preferably between 5.5 and 10 degrees centigrade and most preferably 7 degrees centigrade; and the temperature of the third Grovac machine is between −2.2 and 10 degrees centigrade, preferably between −1.6 and 5.0 degrees centigrade and most preferably 0.55 degrees centigrade. In one embodiment, the first Grovac machine is set at a cycle speed of six, five seconds long, dips per minute for a total exposure to vacuum and solution time set for 2-4 minutes. The vacuum pressure in each Grovac machine should be between 15 and 30 inches of mercury, preferably between 20 and 28 inches of mercury and most preferably 25 inches of mercury.

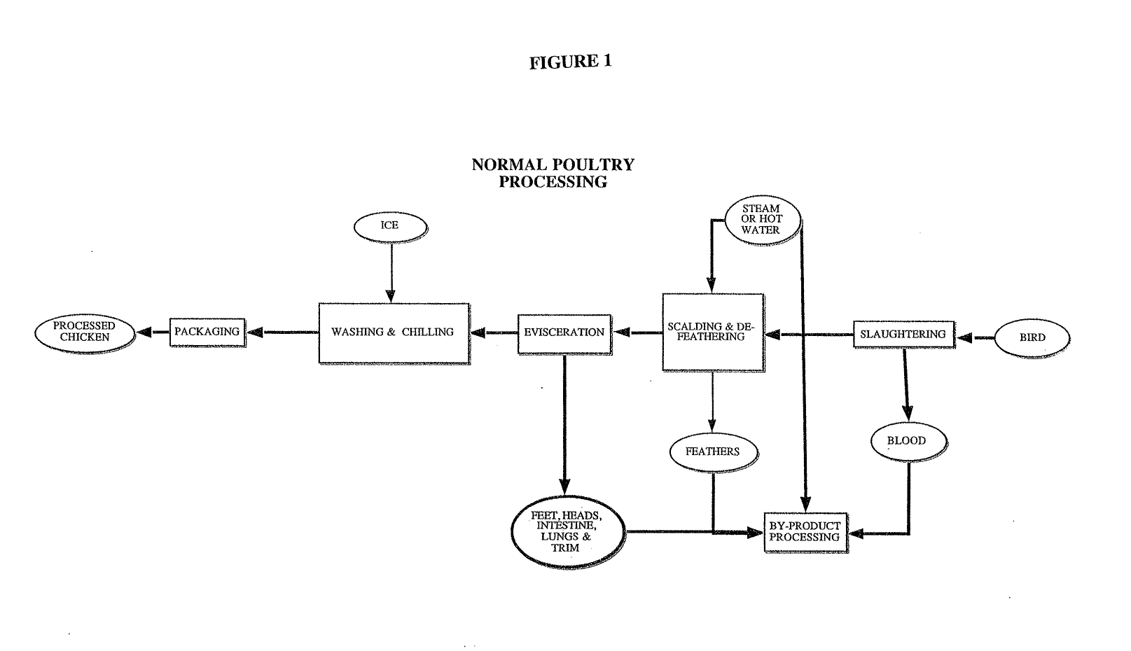

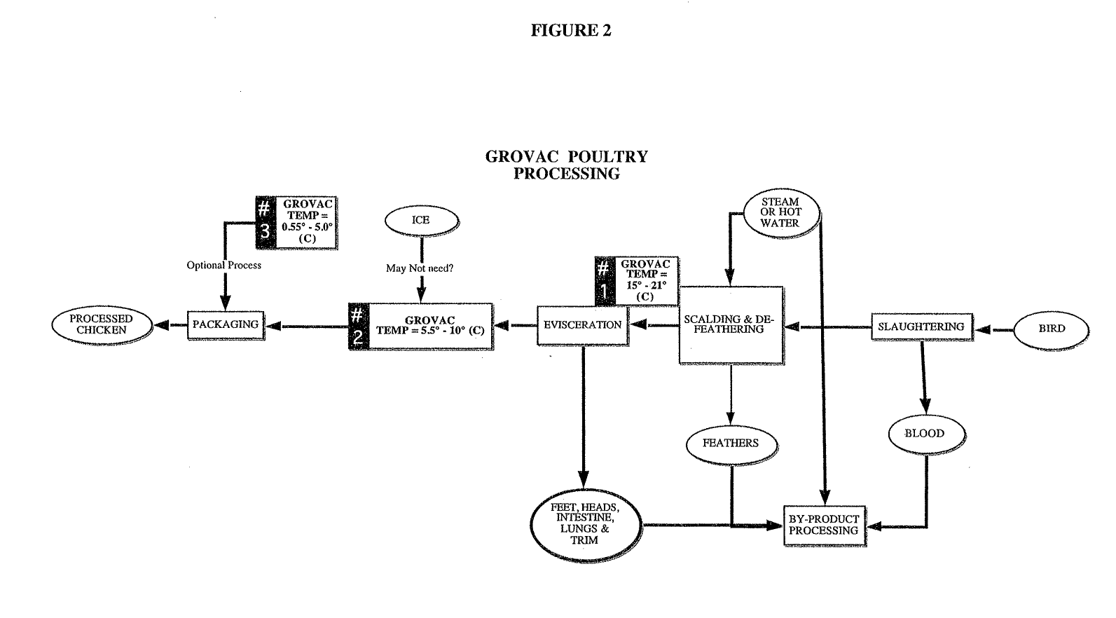

One embodiment of the process according to the invention for use with poultry is depicted in FIG. 2. In FIG. 2, Grovac machine #1 is placed immediately following de-feathering. Grovac machine #2 follows evisceration and replaces the chill tank of prior art processes, as shown in FIG. 1. Grovac machine #2 is longer in length than machine #1. The final machine, #3, is the shortest and occurs just prior to packing for shipping, whether for WOGS, quarters or pieces (wings, drumsticks, etc.)

In the process of FIG. 2, processing solution temperatures will vary from one machine to the next. For instance, machine #1 may be at ambient (from 15° to 21° centigrade) temperature, machine #2 may be from 5.5° to 10° centigrade and machine #3 may be from 0.55° to 5.0° centigrade. Muscle tissue liberates heat much more rapidly in the alternating vacuum than in the constant bath of the chill tank, which does little to remove bacteria from the nooks and crevices of the bird's carcass, and which does not affect any accrued biofilm on the birds. The pH of the solution should remain consistent from machine to machine, although lengths of time for the immersion/vacuum cycle may vary among the different machines. Solution and vacuum pressures should remain consistent throughout the procedure and among the different machines.

In prior art methods for treating poultry, water currently used for washing and chilling totals upwards of 120,000 gallons per chill tank daily. According to the process of the present invention, water requirements would be a third or less of that amount. A filter system incorporated with the Grovac machines would remove accumulated organic material making the water reusable over and over. Sensors in the equipment would monitor the solutions to help maintain the proper chemical balances and pH. The poultry process of the present invention would decrease processing time, use less water volumes, and result in post-processing fluid that is eco-friendly without chlorine or phosphates requiring no special waste water treatment. The same is true for processing any other types of meat, fish, vegetable or fruit.

Sodium chloride and an organic acid are the only additives in the water according to one embodiment of the present invention, preferably used for meat products. Both are naturally occurring components and few bacteria survive the multihurdle technology. The chemical balance of the solution is often altered to produce a specific product outcome as desired by the customer. Grovac's natural ingredients control undesirable oxidative activity without using phosphates. However, phosphates added after processing according to the invention is a processor option. The pH of the solution in each machine is carefully monitored to ensure that targeted pathogens are killed. In a preferred embodiment, the pH is maintained between 1 and 9, most preferably below 3.8.

In another embodiment, the invention is directed to a raw food processing system for removing pathogens from raw food comprising a) providing at least one Grovac machine containing a vacuum and an aqueous solution and a means for conveying the raw food into and through the vacuum and aqueous solution in the at least one Grovac machine continuously; b) providing raw food; c) subjecting the raw food to treatment in at least a first Grovac machine; wherein the aqueous solution comprises a sodium chloride and organic acid; and wherein the temperature of the at least one Grovac machine is between −2.2 and 24 degrees centigrade. In this embodiment, the Grovac machine may be that which is described in U.S. patent application Ser. No. 12/440,751, which has been herein incorporated by reference. In another embodiment, at least two Grovac machines are used.

In another embodiment, the present invention provides a process for improving the taste and extending the shelf-life of soy beans and products made therefrom, including, but not limited to soy bean oil and soy protein isolates. The present invention also relates to food products comprising the soy bean meal made according to the invention. The process generally involves providing soy beans in a Grovac machine that is vacuum tumbler equipped with lifting ribs and tumbling the soy beans in an alternating environment of a vacuum and an acidic solution. This process could be part of a continuous process, as described above, or a batch process, which used one machine. In any event, the process of the present invention calls for the vacuum tumbling for a set period of time in an acidic solution with a pH lower than 7.0 of soy beans. The pressure may be maintained at any point between 15 and 28 inches of mercury, preferably at 25 inches of mercury.

As a consequence of the process, the offensive “beany” taste is eliminated and the soy beans and products derived therefrom (oil, flour, etc.) are palatable to humans. Additionally, the fat in the soy beans is stabilized against internal or external oxidative processes. Once this is complete the soy beans are removed from the vacuum tumbler and dried. The amount of moisture removed should be at least enough to allow further processing of the soy beans into texturized and extruded products, flakes, flour, or meal form.

As used herein in connection with soy bean processing, the vacuum tumbling process involves mechanically tumbling soy beans in a tumbler device, massager and/or chamber. The soy beans may be whole or partially processed soy beans, such as cracked soy beans. Vacuum tumbling may enhance cleaning and expose greater cellular membrane areas to the process, through mechanical stresses. The mechanical stresses of vacuum tumbling may also contribute to bacterial lysis, which improves the shelf life of the soy beans. With this in mind, the tumbling speed may range from about 2 to about 14 RPM, 4 to 10 RPM or 6 to 9 RPM, or at any point within these ranges. In a typical run the vacuum tumbling may be conducted at about 8 RPM.

In the Grovac machines of the present invention, the vacuum tumbler is equipped with special ribs that have been designed to lift the product completely out of an acidic solution, to about the 1-2 o'clock position before a free fall back into the solution. This allows the product to have much more exposure to the vacuum environment.

Other conditions for the vacuum tumbling process of soy beans include having a temperature ranging from about 0.5° C. to about 27° C., about 5.0° C. to about 20° C. or about 10° C. to about 15° C. or at any point within these ranges. Although the available range for conducting the process is fairly broad, generally the soy beans are processed near ambient temperatures. This is in stark contrast to the high temperatures required by typical soy bean refining processes. Thus, the immediate benefit of the present invention is a process that is less energy intensive.

In one embodiment, the soy beans used in the present invention have not been pretreated with hexane, acetone or any other solvent.

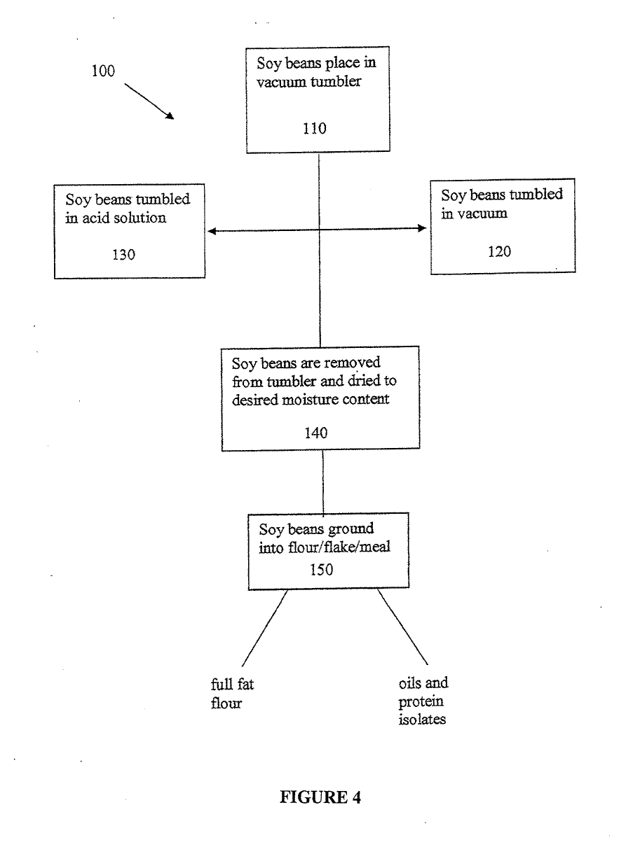

Referring now to FIG. 4, the process 100 begins by placing soy beans in a vacuum tumbler, at step 110. The soy beans are then tumbled in an alternating environment of a vacuum step 120 and an acidic solution step 130. The soy beans are cycled through the vacuum and acidic solution in 4-20 minute intervals. In a preferred embodiment, soy beans are tumbled for about 4-12 minutes. In a most preferred embodiment, the soy beans are tumbled for about 6 minutes. During the vacuum cycle, the vacuum may be in a range from about 15 to about 28 and preferably 25 inches of mercury. Such low vacuums can be obtained, for example, by water aspiration. The soy beans are removed and then a sufficient amount of water is removed at step 140 to allow grinding them into flour, flake, or meal at step 150. Processing beyond this point to generate soy bean protein isolates or oils are performed under standard conditions performed in a typical soy mill, including processing textures and extrusions.

Various chemical aspects of the present invention also enhance the quality and flavor of the food products and improve their shelf life. The acidic solution may have a pH ranging from about 2.0 to about 7.0, 2.4 to about 6.5, about 3.0 to about 5.0 and any point within these ranges. The process allows for a fairly broad range of pH with the best results being obtained by having a pH less than 7. However, in contrast to methods of processing meat or fish products, the solution into which the soy beans are submerged does not contain salt or any type of hypotonic solution. Thus, in one embodiment, the solution may consist of water and an organic acid. In one embodiment, preferably only one organic acid is used. The organic acid should be an organic acid suitable for food use if the end product soy bean is to be used for human or animal consumption. Examples of such organic acids include, but are not limited to citric acid, ascorbic acid, lactic acid, tartaric acid, acetic acid and benzoic acid. In another embodiment, one or more organic acids are used.

The soy beans that are produced by this process may be used in the formation of a soy bean product such as a flour, a flake, and a meal. Typically, after grinding the soy beans may be processed by conventional methods into soy protein isolates or the oils may be extracted for both food consumption and for biodiesel fuel processing. Flavoring and other additives, known in the art, can be added to the soy bean meal or soy bean flour.

An important aspect of the Grovac processing results in soy beans and then soy bean products, having Iodine Values lower than those obtained by existing industry standards. Iodine value (IV) is a measure of the total number of double bonds present in fats and oils. It is generally expressed in terms of the number of grams of iodine that will react with the double bonds in 100 grams of fats or oils. A high IV oil contains a greater number of double bonds than a low IV oil. Edible oils with high iodine value are usually less stable and more susceptible to oxidation.

A soy bean product having an Iodine Value in a range from about 90 to 120, may be achieved by the process described above. Such soy bean products include the soy beans themselves, the soy bean oil extracts, as well as the soy protein isolates. The lower Iodine Value of soy bean oil (typically around 108) makes it eligible as a feedstock for biodiesel in Europe, whereas regular refined soy bean oil cannot so qualify because it has an Iodine Value in excess of 120, which is the maximum permitted by applicable EU regulations.

Soy beans processed as described may have improved taste and have extended shelf life. Of even greater interest, oil produced from these processed soy beans contains negligible amounts of trans fats (i.e. is substantially free of trans fats save those that are naturally occurring) and yet it has greater stability, longer shelf-life and less tendency to become rancid than unprocessed, unhydrogenated soy bean oil. Therefore, the process presents a completely new, heretofore unknown method of stabilizing soy bean oil, without creating unhealthy trans fats as a byproduct.

Advantageously, the vacuum tumbling process described herein also is non-thermal and therefore requires little energy expenditure, and the ingredients involved are innocuous, requiring no special handling, and are relatively inexpensive. Because the process works on the actual soy bean, no special treatment or handling is required. The processed soy bean remains “fresh” for an indefinite period of time if stored properly. Finally, the process is less expensive to perform than standard industry hydrogenation, and requires the consumption of materially less energy, since the process is non-thermal.

In another embodiment, the invention is directed to soy bean meal. “Protegold®” is soy bean meal in the form of pellets, wherein the meal has been mechanically extracted, without hexane, and has been produced from soy beans processed according to a Grovac vacuum tumbler process described above. Protegold®” has a neutral taste. It can be made into a flour by pressing through sieve, or hammer or mill/grinder.

The protein content of Protegold® is 43-55%, preferably 46-51%, and most preferably 46.41% protein, has a moisture that is 0-12%, preferably 3-12%, and most preferably 5-9%. In one embodiment, the moisture content is 5.93%. The fat content is 0-12%, preferably 5-10% and most preferably 5.21%, the fiber content is 1-9%, preferably 2-6% and most preferably is 2.93%. In one embodiment, Protegold® has a protein content of 46.41%, moisture content of 5.93%, fat content of 5.21%, ash content of 6.35%, calcium content of 0.210%, sodium content 135.0 ppm, iron, 81.9 ppm, calories 377, calories from fat 47, carbohydrate content of 36 g/100 g, dietary fiber content of 8.6%, sugar content of 11.9%, transfat content of 0.2%, vitamin C less than 100 ppm, and cholesterol content of less than 0.1%. The water holding capacity of soy bean meal produced by the above system is 20% higher than soy bean meal not from soy beans pretreated by a Grovac process, according to the present invention.

One of skill in the art would understand that many products could be made using soy meal (Proteogold®), produced from soy beans processed with a Grovac process, according to the present invention. Such products include snack foods, cereals, breads, meat products containing soy and soy products that have the texture of meat and are meat replacements, such as soy burgers and hot dogs and chicken, and other food additives. In one preferred embodiment, the soy meal is made into “soy puffs”.

According to the present invention, the above described pre-treated soy beans are processed into soy pellets or Protegold® that are then processed into a powder, meal or flour (“Protegold® flour”) that is then combined with another farinaceous product. By “farinaceous product” is meant any vegetable or grain product that comprises carbohydrate, including but not limited to, starch, meal or flour from corn, wheat, rice, potato, tapioca, peanut, oats, sorghum, rye, barley, cassava and combinations thereof.

The Protegold® flour and farinaceous product is then combined with a liquid to make a dough. The dough should comprise from 15 to 40%, preferably 20 to 30% and most preferably from 22 to 28% by weight of Protegold® flour, from 60 to 90%, preferably 70 to 80% and most preferably from 72 to 78% by weight of farinaceous product and a liquid. In a preferred embodiment, the farinaceous product is corn meal and the liquid is water. In a particularly preferred embodiment, the dough comprises 25% Protegold® flour, 75% corn meal and water. The dough according to the present invention also may comprise other ingredients, such as salt, colorants, sugar, vitamins and minerals and flavors. In other embodiments, these other embodiments are added after the soy puffs are fabricated.

The dough can be mixed according to any method known to the skilled artisan. In one embodiment, the dry ingredients are mixed together and then cooked to form a gelatinized or “cooked” dough. In one embodiment, the liquid is water and is added to the barrel of an extruder with the farinaceous product and Protegold® flour in order for the dough to develop sufficient plasticity to be extruded. The ingredients typically are premeasured. In a preferred embodiment, the dry and liquid ingredients are mixed under pressure in a conventional single screw or twin screw cooker extruder into which steam is injected to heat and cook the mixture. In one embodiment, the dry mixture is moisturized with steam prior being introduced into the extruder.

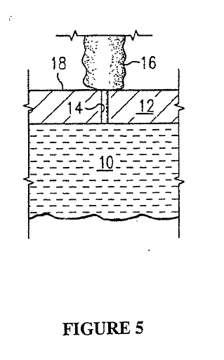

The dough according to the present invention can be puffed according to known puffed cereal or puffed snack apparatus and techniques. One example of a puff extrusion process is illustrated in FIG. 5, which is a schematic cross-section of a die 12 having a small diameter exit orifice 14. In manufacturing a Protegold® flour puff product, a combination of Protegold® flour/corn meal (“the meal”) is added to, typically, a single (i.e., American Extrusion, Wenger, Maddox) or twin (i.e., Wenger, Clextral, Buhler) screw-type extruder such as a model X 25 manufactured by Wenger or BC45 manufactured by Clextral of the United States and France, respectively. Water is added to the meal while in the extruder, which is operated at a screw speed of 100 to 1000 RPM, in order to bring the overall water content of the meal up to 12% to 18%. The meal becomes a viscous melt 10 as it approaches the die 12 and is then forced through a very small opening or orifice 14 in the die 12. The diameter of the orifice 14 typically ranges between 2.0 mm and 12.0 mm for a meal formulation at conventional moisture content, throughput rate, and desired extrudate rod diameter or shape. However, the orifice diameter might be substantially smaller or larger for other types of extrudate materials.

While inside orifice 14, viscous melt 10 is subjected to high pressure and temperature, such as 600 to 3000 psi and approximately 400 degrees F. Consequently, while inside the orifice 14, the viscous melt 10 exhibits a plastic melt phenomenon wherein the fluidity of the melt 10 increases as it flows through the die 12. The extrudate 16 exits the orifice 14, and rapidly expands, cools, and very quickly goes from the plastic melt stage to a glass transition stage, becoming a relatively rigid structure, referred to as a “rod” shape if cylindrical, puff extrudate. This rigid rod structure can then be cut into small pieces and dried or further cooked by, for example, frying, and seasoned as desired.

Several dies 12 can be combined on an extruder face in order to maximize the total throughput on any one extruder. For example, when using the twin screw extruder and meal formulation described above, a typical throughput for a twin extruder having multiple dies is 2,200 lbs., a relatively high volume production of extrudate per hour, although higher throughput rates can be achieved by both single and twin screw extruders. At this throughput rate, the velocity of the extrudate as it exits the die 12 is typically in the range of 1000 to 4000 feet per minute, but is dependent on the extruder throughput, screw speed, orifice diameter, number of orifices and pressure profile.

Although the above product produced by such process is a linear extrusion which, even when cut, results in a linear product, the method of the present invention includes other configurations, such as making curls or spirals or coils, according to methods well known in the art.

In another embodiment, the invention relates to soy puffs produced according to the above process. Such soy puffs are low in fat, comprise high amounts of dietary fiber and protein and are good tasting. This invention has created a snack puff that is neutral in flavor when unseasoned and has two times the protein and dietary fiber content of comparable snack puffs. Soy puffs made from soy bean meal flour (Protegold® flour), according to the invention, and corn meal comprise at least five grams of protein and at least 1.39 grams of dietary fiber per ounce. In one embodiment, soy puffs fabricated from 25% soy bean flour, 75% corn meal and water comprise 16.5% protein (dry weight), 2.6% moisture, 0.96% fat (dry weight) and 4.9% dietary fiber (dry weight). In another embodiment, soy puffs fabricated from a dough comprising 25% soy bean meal flour, 75% corn meal and water comprise 5 to 25% protein (dry weight), 1-4% moisture, at least 0.1% fat (dry weight) and 3 to 6% dietary fiber (dry weight).

Thus, in one embodiment, the invention is directed to a method of producing soy puff products comprising the steps of:

(a) preparing soy pellets, and

(b) preparing a dough comprising soy bean flour made from the soy pellets

(c) extruding the dough comprising the soy bean flour through a pressurized heat extruder under conditions to expand the dough comprising soy pellets to form soy puffs, wherein in step (a), the soy pellets are prepared by the process comprising:

(i) providing soy beans in a vacuum tumbler equipped with lifting ribs;

(ii) tumbling the soy beans in a temperature range from about 0.5° C. to about 27° C. in an alternating environment of a vacuum and an acidic solution that is not hypotonic and does not comprise sodium, wherein the lifting of the ribs lift the soy beans completely out of the acidic solution when the soy beans is in the vacuum environment;

(iii) removing the moisture from the soy beans;

(iv) cracking the soy beans and mechanically removing oil from the soy beans;

(v) grinding the cracked soy beans to form soy meal;

(vi) extruding the soy meal to form soy pellets.

In another embodiment, the soy puffs according to the invention are fabricated from soy bean meal flour, corn meal and water, and comprise at least 5 grams of protein and at least 1.39 grams of dietary fiber per ounce. In another embodiment, the soy puffs according to the invention are fabricated from 25% soy bean meal flour, 75% corn meal and water, and comprise 16.5% protein (dry weight), 2.6% moisture, 0.96% fat (dry weight) and 4.9% dietary fiber (dry weight). In yet another embodiment, the soy puffs according to the invention are “fabricated from a dough comprising 25% soy bean meal flour, 75% corn meal and water, wherein the soy puffs comprise 5 to 25% protein (dry weight), 1-4% moisture, at least 0.1% fat (dry weight) and 3-6% dietary fiber (dry weight).

In another embodiment, the invention is directed to meat products comprising Protegold®. With expanding population, it has becoming increasingly necessary to fortify animal protein with non-animal protein as well as to fortify non-animal protein with animal protein. Much research has been done on the use of various soy bean by-products as extenders in meat products.

Other products that could incorporate Protegold® include soups, doughs and pet food. Also, the high protein content in the Protegold® flour is an added advantage due to value addition. Hence by solubilizing and separating the protein from Protegold®, protein concentrates can be prepared which can be used as protein sources and emulsifiers in food systems.

The following Examples are not intended to limit the invention in any way.

### EXAMPLES

### Example 1

Soy beans were processed by the vacuum tumbler process described above and Protegold® was mechanically produced. That is, soy beans were put into a vacuum tumbler with an aqueous solution containing an organic acid having a pH of 2.5 to 4.0 and rotated at 8 RPM for 6 to 20 minutes. The vacuum was maintained at about 25 inches of mercury. The soy beans were then dried enough to permit oil extraction and were mechanically grinded to make the meal (Protegold®). The so produced Protegold® was tested for protein content, water holding capacity, and protein solubility.

A variety of different meat patties were then made which incorporated the Protegold®. An in-house sensory evaluation was conducted to analyze the Protegold®'s effect on the texture, moisture and taste of the meat patties. Commercial soy bean meal incorporated patties was included for comparison. These comparative studies are described below.

### The Study

Protegold® had approximately 66% protein and showed high protein solubility in alkaline pH. It showed higher water holding capacity (67%) than commercial soy meal (44%). In the sensory test with beef, pork, chicken and turkey meat patties incorporated with Protegold®, it scored higher in comparison to commercial soy meal in terms of texture, moisture and taste. Protegold® at 10% concentration is the maximum amount that can be used without altering the quality of the product drastically. However incorporating 5% was the maximum amount that can be used without altering the taste and texture of the meat patty samples. Sensory evaluation of meat patties with either 0.4% phosphate or 0.8% salt showed comparable results with patties incorporated with 5% Protegold® without the addition of salt. Substitution or replacement of phosphates with 5% Protegold® and 5% water did not alter moisture, texture and taste in the beef, pork, turkey, and chicken patties. Based on the results it is concluded that Protegold® at a level of 5% can be incorporated in producing various meat patties without altering physic-chemical properties and sensory characteristics. This is an application where Protegold® can find value addition especially in beef and chicken patties for a better profit margin.

Quality of protein from a source was evaluated using the protein efficiency ratio based on the weight gain of a test subject divided by its intake of a particular food protein. This is related to the protein digestibility score, a method to evaluate protein quality based amino acid requirements of humans and their ability to digest it is called Protein Digestibility Corrected Amino Acid Score (PDCAAS). Protein digestibility score for soy protein was 1.0 which is the highest while that of beef is 0.92 (Schaafsma 2000 and López et al 2006).

Objective:

To determine protein, moisture and water holding capacity of Protegold®flour, and evaluate the effect of incorporating Protegold® at various levels on sensory attributes in beef, turkey, pork and chicken meat patties.

Materials and Supplies:

Beef trimmings (50 s and 90 s) with two levels of fat (10% and 50% respectively), pork (26% fat) and chicken (20% fat) and turkey meat (25% fat) were provided by local companies. All chemicals and supplies for the study were purchased from VWR INC. Commercial soy bean meal used for comparison was provided by ADM Inc, Decatur, Ill.

### Procedures:

Moisture and Protein Content Determination.

Protegold® pellets provided by Protegold® Company were ground and sieved through 60 mesh to prepare flour. The flour was sampled and the moisture content was determined using the AACC official method: 44-15A. To determine the moisture content, the samples were dried in a hot air oven at 135° C. for 3 hours and the weights of the samples before and after drying were recorded to calculate the moisture content of the sample. Protein content of the flour was determined by Kjeldahl method (AACC official method: 46-12).

Protegold® Protein Solubility Determination.

Suspensions of the flour were prepared in deionized (DI) water (10% w/v) and the samples were subjected to either highly acidic pH (2.0) or high alkaline pH (9.5) conditions separately to test the protein solubility from the flour. Sample with no pH alteration was used as control. All samples were prepared in triplicate. The suspensions were stirred for one hour and centrifuged at 3000 g for 15 min. The supernatants from each treatment were collected and the residue was separated. Protein content in the supernatant was determined using the Kjeldahl method. Protein solubility was calculated as a ratio between protein content in solution and Protegold® flour and expressed as percentage using the formula:

(Pₐ/P_{b})*100

where Pₐ=Protein content in solution, P_{b}=Protein content in Protegold® flour.

Water Holding Capacity (WHC) Determination.

WHC of Protegold® was determined by suspending 2 g of flour in 10 mL of DI water and stirring for one hour. The sample was centrifuged and the weight of the residue was determined to calculate the percentage of moisture in the flour. Commercial soy bean meal was included for comparison. WHC is expressed as a percentage of water in the residue to that in the flour or meal using the formula:

(Wₐ/W_{b})*100;

where Wₐ=Moisture content in the flour, W_{b}=Moisture content in the residue.

Meat Patty Preparation for Sensory Test.

The pork, turkey and chicken patties were prepared by grinding the respective meats to a homogeneous emulsion. The beef trimmings (50 s and 90 s) were mixed in the ratio of 3:2 respectively to prepare beef with approximately 20% fat content (80 s) in the final product. All four ground raw meats were mixed with water and Protegold® in varying proportions to prepare patties as follows: control (patty with no water or Protegold®), patty with 5% water, patty with 10% water, patty with 5% Protegold®, patty with 10% Protegold®, patty with 5% water+5% Protegold®, patty with 10% water+10% Protegold® and patty with 5% commercial soy bean meal. Another trial was conducted that included 0.4% phosphates and 0.8% of salt along with the commercial soy bean meal for comparing the results. The treatments were: control (only meat), 5% commercial soy bean meal, 5% Protegold®+5% water, 0.4% phosphate, 0.4% phosphate+5% Protegold®+5% water, 0.4% phosphate+0.8% salt.

Precooked weight of the patties, weight of the cooked patties and drip weight/drip losses from the patties were monitored. The patties were cooked at an internal temperature of 165° F. for 5 minutes. Sensory attributes (moisture, texture and overall taste) of the patties were evaluated by a 5 member sensory panel with scores on a hedonic scale: 1 being least and 6 being the highest.

### Results and Discussion:

Protein Content and Water Holding Capacity of Protegold®.

The moisture content in the flour was 5.7%. On a dry basis the protein content was approximately 66% (Table 1). At alkaline pH (9.5 pH) approximately 20% of protein was solubilized that was significantly higher than the solubility at acidic pH (2 pH) (Table 1). Treatment with alkaline pH for a longer duration (3 hr) may have solubilized more protein from the flour. In comparison to commercial soy bean meal, Protegold® has significantly higher water holding capacity (Table 1) which can promote its use in food products which require higher moisture levels to maintain the rheological properties.

TABLE 1
Moisture, protein content and water holding capacity of Protegold ® and
protein prepared after treatment from ProtegoldTM.

| | Protein (dry basis) and properties |
|---|---|
| Moisture | |
| 5.7 ± 0.9% | Protegold ® flour as is - 65.91 ± 3.2% |
| | Protegold ® flour, acid treated - 57.60 ± 1.3% |
| | Protegold ® flour, alkali treated - 44.54 ± 2.9% |
| | Protegold ® flour, no treatment - 63.53 ± 3.5% |
| Property | |
| Water holding | Protegold ® - 67.88 ± 1.9% |
| capacity | Commercial soy bean meal - 44.7 ± 1.7% |

Note:
No Treatment = Suspension of Protegold ® in DI water stirred at room temperature for one hour. Values were means ± standard deviation. Suspensions of the samples were made in deionized water (10% w/v) for treating with acidic (2.0) or alkaline (9.5) pH. Protein content in the residue was determined after centrifugation and separation of the supernatant.

Sensory Evaluation.

All tested patties were baked to an internal temperature of 170° C. to ensure safety of the product while preserving the flavor. Panelists who have high preference and liking for meat patties were selected for the study. They evaluated all the treatments of the meat patties in the study to identify the treatment that scored highest based on preference for moisture in the patty, texture and taste. Tables 2a, 2b and 2c give the sensory evaluation of 8 treatments (A-H). The maximum score for ranking was 6 (Like very much) while the lowest score was 1 (Dislike). The means from beef patties data suggests that all the subjects liked the taste of the patties treated with 5% Protegold® (Sample D) but they gave a lower score based on its moisture content.

TABLES 2a, 2b and 2c
Sensory evaluation of beef patties with 8 treatments
based on moisture, texture and taste.

Treatments

| | | | | | | | | |
|---|---|---|---|---|---|---|---|---|
| Subjects | A | B | C | D | E | F | G | H |

(2a)

| | | | | | | | | |
|---|---|---|---|---|---|---|---|---|
| Moisture | | | | | | | | |
| I | 5 | 4 | 4 | 6 | 4 | 4 | 6 | 5 |
| II | 5 | 4 | 6 | 3 | 2 | 6 | 4 | 6 |
| III | 5 | 3 | 5 | 4 | 4 | 5 | 5 | 4 |
| IV | 5 | 5 | 6 | 6 | 4 | 5 | 5 | 4 |
| V | 5 | 4 | 4 | 4 | 3 | 5 | 5 | 5 |
| Average | 5 | 4 | 5 | 4.6 | 3.4 | 5 | 5 | 4.8 |

(2b)

| | | | | | | | | |
|---|---|---|---|---|---|---|---|---|
| Texture | | | | | | | | |
| I | 5 | 4 | 4 | 6 | 6 | 6 | 6 | 5 |
| II | 5 | 3 | 5 | 4 | 3 | 4 | 3 | 4 |
| III | 5 | 4 | 5 | 4 | 5 | 5 | 5 | 5 |
| IV | 5 | 5 | 5 | 5 | 4 | 5 | 5 | 5 |
| V | 5 | 4 | 5 | 6 | 6 | 6 | 6 | 5 |
| Average | 5 | 4 | 4.8 | 5 | 4.8 | 5.2 | 5 | 4.8 |

(2c)

| | | | | | | | | |
|---|---|---|---|---|---|---|---|---|
| Taste | | | | | | | | |
| I | 5 | 6 | 4 | 6 | 4 | 5 | 5 | 4 |
| II | 5 | 4 | 4 | 5 | 4 | 3 | 3 | 5 |
| III | 5 | 4 | 5 | 5 | 4 | 4 | 4 | 4 |
| IV | 5 | 5 | 4 | 5 | 4 | 4 | 5 | 4 |
| V | 5 | 5 | 5 | 5 | 4 | 6 | 6 | 5 |
| Average | 5 | 4.8 | 4.4 | 5.2 | 4 | 4.4 | 4.6 | 4.4 |

Note:
Treatments: Table 2a denotes mositure, table 2b denotes texture and table 2c denotes taste of the beef patties. A = Beef patty with 5% commercial soy bean meal; B = Beef patty with 5% water; C = Beef patty with 10% water; D = Beef patty with 5% Protegold ®; E = Beef patty with 10% Protegold ®; F = Beef patty with 5% water + 5% Protegold ®; G = Beef patty with 10% water + 10% Protegold ®; H = Control (Beef patty + no water or Protegold ®). The Roman numerals I to V denote the subjects who participated in the taste test and the scores were given on a Hedonic scale from 1 to 6.

The patties with treatment D scored 6 in all three sensory attributes. Even though the control scored an average of 5 for all three sensory aspects studied, addition of Protegold® improved the moisture and texture as shown by the scores in table 2b and 2c for patties with treatments F and G. A higher amount of Protegold® (10%) without addition of water (treatment E) scored low when comparing the moisture in patties.

TABLES 3a, 3b and 3c
Sensory analysis of pork patties with 8 treatments
based on moisture, texture and taste.

Treatments

| | | | | | | | | |
|---|---|---|---|---|---|---|---|---|
| Subjects | A | B | C | D | E | F | G | H |

(3a)

| | | | | | | | | |
|---|---|---|---|---|---|---|---|---|
| Moisture | | | | | | | | |
| I | 2 | 3 | 3 | 3 | 2 | 2 | 2 | 2 |
| II | 2 | 3 | 3 | 3 | 2 | 2 | 2 | 2 |
| III | 5 | 4 | 4 | 5 | 4 | 5 | 4 | 4 |
| IV | 5 | 3 | 4 | 5 | 6 | 5 | 6 | 4 |
| V | 2 | 2 | 3 | 1 | 1 | 1 | 1 | 4 |
| Average | 3.2 | 3 | 3.4 | 3.4 | 3 | 3 | 3 | 3.2 |

(3b)

| | | | | | | | | |
|---|---|---|---|---|---|---|---|---|
| Texture | | | | | | | | |
| I | 4 | 2 | 3 | 4 | 1 | 1 | 1 | 1 |
| II | 2 | 4 | 3 | 3 | 3 | 2 | 2 | 2 |
| III | 4 | 4 | 4 | 5 | 4 | 5 | 5 | 4 |
| IV | 5 | 3 | 4 | 5 | 6 | 5 | 6 | 4 |
| V | 2 | 3 | 2 | 1 | 1 | 1 | 1 | 4 |
| Average | 3.4 | 3.2 | 3.2 | 3.6 | 3 | 2.8 | 3 | 3 |

(3c)

| | | | | | | | | |
|---|---|---|---|---|---|---|---|---|
| Taste | | | | | | | | |
| I | 1 | 4 | 4 | 4 | 1 | 2 | 1 | 1 |
| II | 3 | 3 | 2 | 4 | 2 | 2 | 2 | 3 |
| III | 4 | 5 | 4 | 3 | 4 | 5 | 4 | 4 |
| IV | 5 | 3 | 4 | 5 | 5 | 5 | 6 | 4 |
| V | 3 | 3 | 2 | 1 | 1 | 1 | 1 | 4 |
| Average | 3.2 | 3.6 | 3.2 | 3.4 | 2.6 | 3 | 2.8 | 3.2 |

Note:
Treatments: Table 3a denotes moisture, table 3b denotes texture and table 3c denotes taste of the pork patties. A = Pork patty with 5% commercial soy bean meal; B = Pork patty with 5% water; C = Pork patty with 10% water; D = Pork patty with 5% Protegold ®; E = Pork patty with 10% Protegold ®; F = Pork patty with 5% water + 5% Protegold ®; G = Pork patty with 10% water + 10% Protegold ®; H = Control (Pork patty + no water or Protegold ®). The Roman numerals I to V denote the subjects who participated in the taste test and the scores were given on a Hedonic scale from 1 to 6.

The study showed that addition of water to Protegold® while preparing the beef patties maintained the moisture content of the patty even after baking at 425° F. The sensory test on the pork patties (Tables 3a, 3b and 3c) showed that treatment with 5% Protegold® was more preferred over others for moisture, texture and taste attributes. All the treatments scored low overall with the highest average score 3.6. The panelists commented on a chalky flavor in the 10% Protegold® treatment. One panelist liked the treatment with 10% water and 10% Protegold® for its moisture content and mouth-feel. Addition of water to Protegold® was also liked by the panelists since as the moisture gave a good mouth feel to the pork meat even after baking.

TABLES 4a, 4b and 4c
Sensory analysis of turkey patties with 8 treatments
based on moisture, texture and taste.

Treatments

| | | | | | | | | |
|---|---|---|---|---|---|---|---|---|
| Subjects | A | B | C | D | E | F | G | H |

(4a)

| | | | | | | | | |
|---|---|---|---|---|---|---|---|---|
| Moisture | | | | | | | | |
| I | 5 | 4 | 4 | 6 | 4 | 4 | 6 | 4 |
| II | 5 | 4 | 6 | 3 | 2 | 6 | 4 | 2 |
| III | 5 | 3 | 5 | 4 | 4 | 5 | 5 | 6 |
| IV | 5 | 5 | 6 | 6 | 4 | 5 | 5 | 3 |
| V | 5 | 4 | 4 | 4 | 3 | 5 | 5 | 4 |
| Average | 5 | 4 | 5 | 4.6 | 3.4 | 5 | 5 | 3.8 |

(4b)

| | | | | | | | | |
|---|---|---|---|---|---|---|---|---|
| Texture | | | | | | | | |
| I | 5 | 4 | 4 | 6 | 6 | 6 | 6 | 4 |
| II | 5 | 3 | 5 | 4 | 3 | 4 | 3 | 2 |
| III | 5 | 4 | 5 | 4 | 5 | 5 | 5 | 6 |
| IV | 5 | 5 | 5 | 5 | 4 | 5 | 5 | 5 |
| V | 5 | 4 | 5 | 6 | 6 | 6 | 6 | 4 |
| Average | 5 | 4 | 4.8 | 5 | 4.8 | 5.2 | 5 | 4.2 |

(4c)

| | | | | | | | | |
|---|---|---|---|---|---|---|---|---|
| Taste | | | | | | | | |
| I | 2 | 2 | 3 | 2 | 5 | 2 | 4 | 4 |
| II | 5 | 4 | 4 | 5 | 4 | 3 | 3 | 3 |
| III | 5 | 4 | 5 | 5 | 4 | 4 | 4 | 6 |
| IV | 5 | 5 | 4 | 5 | 4 | 4 | 5 | 5 |
| V | 5 | 5 | 5 | 5 | 4 | 6 | 6 | 4 |
| Average | 4.4 | 4 | 4.2 | 4.4 | 4.2 | 3.8 | 4.4 | 4.4 |

Note:
Treatments: Table 4a denotes moisture, table 4b denotes texture and table 4c denotes taste of the turkey patties. A = Turkey patty with 5% commercial soy bean meal; B = Turkey patty with 5% water; C = Turkey patty with 10% water; D = Turkey patty with 5% Protegold ®; E = Turkey patty with 10% Protegold ®; F = Turkey patty with 5% water + 5% Protegold ®; G = Turkey patty with 10% water + 10% Protegold ®; H = Control (Turkey patty + no water or Protegold ®). The Roman numerals I to V denote the subjects who participated in the taste test and the scores were given on a Hedonic scale from 1 to 6.

The turkey meat was better preferred by the subjects when added with Protegold® than pork. Analysis of data on turkey patties (Tables 4a, 4b and 4c) based on the Hedonic scores showed that the treatment with Protegold® were better liked by the panelists over that with commercial soy bean meal. The commercial soy bean meal scored low due to the ‘beany’ flavor. Even though water was not added to some treatments, the panelists liked the flavor of the Protegold® when mixed with the ground turkey meat. The panelists commented that baking improved the flavor of Protegold®.

TABLES 5a, 5b and 5c
Sensory analysis of chicken patties with 8 treatments
based on moisture, texture and taste.

Treatments

| | | | | | | | | |
|---|---|---|---|---|---|---|---|---|
| Subjects | A | B | C | D | E | F | G | H |

(5a)

| | | | | | | | | |
|---|---|---|---|---|---|---|---|---|
| Moisture | | | | | | | | |
| I | 5 | 4 | 4 | 6 | 4 | 4 | 6 | 5 |
| II | 5 | 4 | 6 | 3 | 2 | 6 | 4 | 2 |
| III | 5 | 3 | 5 | 4 | 4 | 5 | 5 | 5 |
| IV | 5 | 5 | 6 | 6 | 4 | 5 | 5 | 6 |
| V | 5 | 4 | 4 | 4 | 3 | 5 | 5 | 5 |
| Average | 5 | 4 | 5 | 4.6 | 3.4 | 5 | 5 | 4.6 |

(5b)

| | | | | | | | | |
|---|---|---|---|---|---|---|---|---|
| Texture | | | | | | | | |
| I | 5 | 4 | 4 | 6 | 6 | 6 | 6 | 5 |
| II | 5 | 3 | 5 | 4 | 3 | 4 | 3 | 1 |
| III | 5 | 4 | 5 | 4 | 5 | 5 | 5 | 3 |
| IV | 5 | 5 | 5 | 5 | 4 | 5 | 5 | 6 |
| V | 5 | 4 | 5 | 6 | 6 | 6 | 6 | 5 |
| Average | 5 | 4 | 4.8 | 5 | 4.8 | 5.2 | 5 | 4 |

(5c)

| | | | | | | | | |
|---|---|---|---|---|---|---|---|---|
| Taste | | | | | | | | |
| I | 5 | 6 | 4 | 6 | 4 | 5 | 5 | 5 |
| II | 5 | 4 | 4 | 5 | 4 | 3 | 3 | 2 |
| III | 5 | 4 | 5 | 5 | 4 | 4 | 4 | 3 |
| IV | 5 | 5 | 4 | 5 | 4 | 4 | 5 | 6 |
| V | 5 | 5 | 5 | 5 | 4 | 6 | 6 | 5 |
| Average | 5 | 4.8 | 4.4 | 5.2 | 4 | 4.4 | 4.6 | 4.2 |

Note:
Treatments: Table 5a denotes moisture, table 5b denotes texture and table 5c denotes taste of the chicken patties. A = Chicken patty with 5% commercial soy bean meal; B = Chicken patty with 5% water; C = Chicken patty with 10% water; D = Chicken patty with 5% Protegold ®; E = Chicken patty with 10% Protegold ® ; F = Chicken patty with 5% water + 5% Protegold ®; G = Chicken patty with 10% water + 10% Protegold ®; H = Control (Chicken patty + no water or Protegold ®). The Roman numerals I to V denote the subjects who participated in the taste test and the scores were given on a Hedonic scale from 1 to 6.

The chicken patties were the most liked after beef since they had enhanced flavor of chicken. The selected panelists commented on the distinct ‘beany’ flavor of the commercial soy bean meal, while Protegold® gave its distinct flavor to the ground chicken. The analysis of the scores showed that patties with 10% water had highest preference while the treatment with 5% Protegold® and 5% water was liked for good moisture retention and flavor addition to the chicken. The panelists also commented about the chalkiness of the patties due to the commercial soy bean meal, and softer texture of the patties made with 5% Protegold®.

TABLES 6a, 6b and 6c
Sensory analysis of beef patties with 6 treatments
based on moisture, texture and taste.

Treatments

| | | | | | | |
|---|---|---|---|---|---|---|
| Subjects | 1 | 2 | 3 | 4 | 5 | 6 |

(6a)

| | | | | | | |
|---|---|---|---|---|---|---|
| Moisture | | | | | | |
| I | 5 | 2 | 2 | 3 | 5 | 6 |
| II | 5 | 5 | 3 | 3 | 6 | 5 |
| III | 5 | 2 | 3 | 3 | 3 | 5 |
| IV | 5 | 3 | 4 | 4 | 5 | 5 |
| V | 5 | 5 | 5 | 5 | 5 | 5 |
| Average | 5 | 3.3 | 3.5 | 3.3 | 5 | 5.1 |

(6b)

| | | | | | | |
|---|---|---|---|---|---|---|
| Texture | | | | | | |
| I | 5 | 3 | 2 | 3 | 5 | 6 |
| II | 5 | 4 | 2 | 3 | 5 | 5 |
| III | 5 | 2 | 4 | 3 | 3 | 4 |
| IV | 5 | 2 | 2 | 3 | 5 | 5 |
| V | 5 | 5 | 4 | 3 | 2 | 5 |
| Average | 5 | 3.1 | 3 | 2.6 | 4.3 | 5.1 |

(6c)

| | | | | | | |
|---|---|---|---|---|---|---|
| Taste | | | | | | |
| I | 5 | 4 | 3 | 3 | 5 | 6 |
| II | 5 | 5 | 3 | 4 | 5 | 6 |
| III | 5 | 2 | 2 | 2 | 2 | 4 |
| IV | 5 | 4 | 4 | 5 | 5 | 6 |
| V | 5 | 4 | 2 | 4 | 2 | 5 |
| Average | 5 | 3.8 | 2.8 | 3.6 | 3.8 | 5.4 |

Note:
Treatments: Table 6a denotes moisture, table 6b denotes texture and table 6c denotes taste of the beef patties. 1 = Control (only meat); 2 = 5% Commercial soy bean meal; 3 = 5% Protegold ® and 5% water; 4 = 0.4% Phosphate; 5 = 0.4% Phosphate, 5% Protegold ® and 5% water; 6 = 0.4% Phosphate and 0.8% Salt. The Roman numerals I to V denote the subjects who participated in the taste test and the scores were given on a Hedonic scale from 1 to 6.

In the second sensory test, out of 6 treatments in the beef patties, the panelists gave high scores to the patties which had 0.4% phosphate, 5% Protegold® and 5% water for all the three attributes tested (Table 6a, 6b and 6c). The comments from the panelists showed that the patties retained moisture during baking with acceptable texture. Pork patties with 0.4% phosphate, 5% Protegold® and 5% water had highest scores for moisture and texture among all the treatments (Table 7a, 7b and 7c). Even though the 5% commercial soy bean meal treated pork patties scored high for texture; the panelists also commented on the chalky flavor of these patties.

TABLES 7a, 7b and 7c
Sensory analysis of pork patties with 6 treatments
based on moisture, texture and taste.

Treatments

| | | | | | | |
|---|---|---|---|---|---|---|
| Subject | 1 | 2 | 3 | 4 | 5 | 6 |

(7a)

| | | | | | | |
|---|---|---|---|---|---|---|
| Moisture | | | | | | |
| I | 5 | 3 | 2 | 3 | 3 | 3 |
| II | 5 | 5 | 3 | 3 | 3 | 6 |
| III | 5 | 2 | 2 | 2 | 4 | 6 |
| IV | 5 | 3 | 4 | 3 | 4 | 5 |
| V | 5 | 4 | 3 | 5 | 5 | 6 |
| Average | 5 | 3.5 | 3.3 | 3.5 | 4.2 | 5.2 |

(7b)

| | | | | | | |
|---|---|---|---|---|---|---|
| Texture | | | | | | |
| I | 5 | 5 | 5 | 5 | 5 | 5 |
| II | 5 | 5 | 4 | 3 | 3 | 6 |
| III | 5 | 3 | 3 | 2 | 4 | 6 |
| IV | 5 | 6 | 5 | 4 | 6 | 5 |
| V | 5 | 5 | 4 | 5 | 6 | 6 |
| Average | 5 | 5 | 4.5 | 4.2 | 5 | 5.3 |

(7c)

| | | | | | | |
|---|---|---|---|---|---|---|
| Taste | | | | | | |
| I | 5 | 2 | 2 | 3 | 3 | 4 |
| II | 5 | 5 | 4 | 3 | 2 | 6 |
| III | 5 | 3 | 4 | 5 | 4 | 6 |
| IV | 5 | 6 | 5 | 5 | 5 | 6 |
| V | 5 | 3 | 4 | 5 | 5 | 5 |
| Average | 5 | 3.8 | 3.8 | 4.2 | 3.8 | 5.4 |

Note:
Treatments: Table 7a denotes moisture, table 7b denotes texture and table 7c denotes taste of the pork patties. 1 = Control (only meat); 2 = 5% Commercial soy bean meal; 3 = 5% Protegold ® and 5% water; 4 = 0.4% Phosphate; 5 = 0.4% Phosphate, 5% Protegold ® and 5% water; 6 = 0.4% Phosphate and 0.8% Salt. The Roman numerals I to V denote the subjects who participated in the taste test and the scores were given on a Hedonic scale from 1 to 6.

Even though the turkey and chicken patties scored low overall among all the meat patties (Tables 8 and 9) the comments from the panelists suggest their liking for these patties among all the meats. The low scores in tables 8 and 9 were for comparison between treatments for turkey and chicken, but not a comparison between the meats.

TABLES 8a, 8b and 8c
Sensory analysis of turkey patties with 6 treatments
based on moisture, texture and taste.

Treatments

| | | | | | | |
|---|---|---|---|---|---|---|
| Subject | 1 | 2 | 3 | 4 | 5 | 6 |

(8a)

| | | | | | | |
|---|---|---|---|---|---|---|
| Moisture | | | | | | |
| I | 5 | 2 | 3 | 4 | 4 | 6 |
| II | 5 | 3 | 4 | 3 | 3 | 4 |
| III | 5 | 2 | 2 | 2 | 3 | 5 |
| IV | 5 | 2 | 1 | 2 | 1 | 5 |
| V | 5 | 1 | 2 | 2 | 3 | 5 |
| Average | 5 | 2 | 2.4 | 2.6 | 2.8 | 5 |

(8b)

| | | | | | | |
|---|---|---|---|---|---|---|
| Texture | | | | | | |
| I | 5 | 3 | 3 | 4 | 4 | 6 |
| II | 5 | 4 | 4 | 3 | 3 | 4 |
| III | 5 | 2 | 2 | 3 | 3 | 4 |
| IV | 5 | 2 | 3 | 3 | 1 | 5 |
| V | 5 | 1 | 2 | 2 | 4 | 6 |
| Average | 5 | 2.4 | 2.8 | 3 | 3 | 5 |

(8c)

| | | | | | | |
|---|---|---|---|---|---|---|
| Taste | | | | | | |
| I | 5 | 2 | 3 | 4 | 3 | 6 |
| II | 5 | 4 | 4 | 4 | 3 | 5 |
| III | 5 | 2 | 4 | 3 | 4 | 5 |
| IV | 5 | 2 | 2 | 3 | 3 | 5 |
| V | 5 | 1 | 3 | 3 | 5 | 6 |
| Average | 5 | 2.2 | 3.2 | 3.4 | 3.6 | 5.4 |

Note:
Treatments: Table 8a denotes moisture, table 8b denotes texture and table 8c denotes taste of the turkey patties. 1 = Control (only meat); 2 = 5% Commercial soy bean meal; 3 = 5% Protegold ® and 5% water; 4 = 0.4% Phosphate; 5 = 0.4% Phosphate, 5% Protegold ® and 5% water; 6 = 0.4% Phosphate and 0.8% Salt, The Roman numerals I to V denote the subjects who participated in the taste test and the scores were given on a Hedonic scale from 1 to 6.

The panelists liked the chicken patties better than turkey when incorporated with Protegold®. Only the phosphate treatment scored high among all except the control (no treatment). Since addition of phosphates is becoming a major health concern in the food industry, substitution with Protegold® can be effective way to keep the textural quality, taste and moisture retention aspects of meat patties. The panelists commented on distinct flavor and the dryness of the patties with Protegold® which can be altered by adding low amounts of salt that will keep the sodium content low in the product.

TABLES 9a, 9b and 9c
Sensory analysis of chicken patties with 6 treatments
based on moisture, texture and taste.

Treatments

| | | | | | | |
|---|---|---|---|---|---|---|
| Subject | 1 | 2 | 3 | 4 | 5 | 6 |

(9a)

| | | | | | | |
|---|---|---|---|---|---|---|
| Moisture | | | | | | |
| I | 5 | 2 | 2 | 4 | 4 | 6 |
| II | 5 | 4 | 3 | 5 | 4 | 6 |
| III | 5 | 2 | 3 | 4 | 2 | 3 |
| IV | 5 | 3 | 3 | 4 | 3 | 6 |
| V | 5 | 2 | 3 | 2 | 3 | 5 |
| Average | 5 | 2.6 | 2.8 | 3.8 | 3.2 | 5.2 |

(9b)

| | | | | | | |
|---|---|---|---|---|---|---|
| Texture | | | | | | |
| I | 5 | 4 | 3 | 4 | 5 | 6 |
| II | 5 | 3 | 4 | 4 | 5 | 5 |
| III | 5 | 3 | 3 | 2 | 2 | 2 |
| IV | 5 | 3 | 3 | 4 | 3 | 6 |
| V | 5 | 2 | 4 | 3 | 3 | 6 |
| Average | 5 | 3 | 3.4 | 3.4 | 3.6 | 5 |

(9c)

| | | | | | | |
|---|---|---|---|---|---|---|
| Taste | | | | | | |
| I | 5 | 4 | 3 | 4 | 4 | 5 |
| II | 5 | 3 | 4 | 4 | 5 | 6 |
| III | 5 | 3 | 3 | 3 | 3 | 4 |
| IV | 5 | 2 | 3 | 5 | 3 | 6 |
| V | 5 | 1 | 2 | 2 | 5 | 6 |
| Average | 5 | 2.6 | 3 | 3.6 | 4 | 5.4 |

Note:
Treatments: Table 9a denotes moisture, table 9b denotes texture and table 9c denotes taste of the chicken patties. 1 = Control (only meat); 2 = 5% Commercial soy bean meal; 3 = 5% Protegold ® and 5% water; 4 = 0.4% Phosphate; 5 = 0.4% Phosphate, 5% Protegold ® and 5% water; 6 = 0.4% Phosphate and 0.8% Salt. The Roman numerals I to V denote the subjects who participated in the taste test and the scores were given on a Hedonic scale from 1 to 6.
Conclusion: Study shows that Protegold ® is a good source of protein with higher water holding capacity than commercial soy bean meal. Sensory evaluation of the beef patties with Protegold ® demonstrated its potential use in increasing the moisture content of the patties without affecting the mouth-feel, texture and taste. All panelists agreed that there was a distinct taste difference between the soy bean meal and the Protegold ® patties. It was commented by all the members that the chalky flavor due to the commercial soy bean meal was evident while the Protegold ® had its own flavor which could be improved by adding suggested ingredients like salt, pepper, oregano, onions, or peppers. Addition of phosphates and salt in the patties scored high but these chemicals are not preferred. In food product development, phosphates have been replaced with alternatives for functionality and this approach can be taken to eliminate phosphates from meat patty products. Optimized amounts of Protegold ® and water (5% each) is an efficient way to add value without altering sensory quality of patties. Extrusion diminished the beany flavor by efficient inactivation of enzymes. Protegold ® is a good ingredient in meat industry especially in improving the functionality of patties. Other product application needs can be met because of Protegold ®'s functional and ‘flavor-friendly’ properties.

### REFERENCES

1. Schaafsma G 2000. “The protein digestibility-corrected amino acid score”. The Journal of Nutrition 130(7): 1865S-7S.
2. Suárez López M M, Kizlansky A, López L B 2006. Assessment of protein quality in foods by calculating the amino acids score corrected by digestibility (in Spanish). Nutrición Hospitalaria 21(1): 47-51.
3. American Association of Cereal Chemists (1982). Approved Methods of the AACC. Official Methods: 44-15A. Final approval 10-30-75; revised 10-28-81.
4. American Association of Cereal Chemists (1982). Approved Methods of the AACC. Official Methods: 46-13. Final approval 10-8-76; reviewed 10-27-82, revised 10-8-86.

From the foregoing detailed description of specific embodiments of the invention, it should be apparent that a method for processing raw foods and particularly soy beans and producing food products comprising such soy beans that are novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

We claim:

1. A method of eliminating the off-flavor of soy beans, wherein the off-flavor of the soy beans is not related to geosmin, the method comprising:
providing soy beans in a vacuum tumbler equipped with lifting ribs;
tumbling the soy beans in a temperature range from about 0.5° C. to about 27° C. in an alternating environment of a vacuum and an acidic solution that is not hypotonic and does not comprise sodium, wherein the lifting of the ribs lift the soy beans completely out of the acidic solution when the soy beans are in the vacuum environment;
and
removing at least a portion of the moisture from the soy beans; wherein said process produces soy beans that have no-off flavor are free of trans fats and retain good flavor.

2. The method of claim 1, wherein a tumbling speed ranges from about 2 to about 14 RPM.

3. The method of claim 1, wherein the acidic solution has a pH ranging from about 2.4 to about 6.5.

4. The method of claim 1, wherein the acidic solution comprises and consists essentially of aqueous solution of an organic acid.

5. The method of claim 4, wherein the organic acid is selected from the group consisting of citric acid, ascorbic acid, lactic acid, tartaric acid, acetic acid and benzoic acid.

6. The method of claim 1, wherein the vacuum is in a range from about 15 to about 28 inches of mercury.

7. The method of claim 1, further comprising grinding the soy beans to produce soy bean meal or flour.

8. Soy bean meal produced according to the method of claim 7.

9. Soy bean flour produced by the method of claim 7.

10. Meat products comprising the soy bean meal of claim 8.

11. A snack food comprising the soy bean meal of claim 8.
